(19) United States
(12) Patent Application Publication
(10) Pub. No.: US 2010/0161932 A1
(43) Pub. Date: Jun. 24, 2010

(54) METHODS FOR WRITING DATA FROM A SOURCE LOCATION TO A DESTINATION LOCATION IN A MEMORY DEVICE

(76) Inventors: Ori Moshe Stern, Modeen (IL); Micha Rave, Herzliya (IL); Robert David Selinger, San Jose, CA (US); Sandra Almog Goldschmidt, Herzliya (IL)

Correspondence Address: BRINKS HOFER GILSON & LIONE/SanDisk, P.O. BOX 10395, CHICAGO, IL, 60610, US

(21) Appl. No.: 12/338,378

(22) Filed: Dec. 18, 2008

(51) Int. Cl. G06F 12/06; G06F 12/08

(52) U.S. Cl. 711/202; 711/103; 711/114; 711/E12.008; 711/E12.078; 711/E12.019

(57) ABSTRACT

Methods for writing data from a source location to a destination location in a memory device are provided. In one embodiment, a memory device receives a command from a host device, wherein the command specifies a logical address of a source location in the memory and a logical address of a destination location in the memory. The memory device translates the logical addresses of the source and destination locations to physical addresses of the memory, reads data from the source location, and writes the data to the destination location. In this embodiment, the data is read from the source location and written to the destination location without a need of further involvement of the host device after the host device sends the command to the memory device. Other embodiments are provided.

### BACKGROUND

Memory devices are often used to store data provided by a host device. In many situations, the host device needs to copy or move previously-stored data from one location in the memory device to another location in the memory device, such as, for example, when the host device is defragmenting the memory device. Standard storage device interfaces, such as Serial Advanced Technology Attachment (SATA), FiberChannel, and Serial Attached SCSI (SAS), do not define commands to trigger the memory device to perform a copy or move operation on its own based on logical addresses provided by the host device. Accordingly, to copy or more data in the memory device, the host device uses standard read/write commands in existing storage device interfaces. Specifically, the host device sends a standard read command to the memory device via a bus and specifies a logical address of a source location in the memory. The memory device then translates the logical address to a physical address, reads the data from the source location, and sends the read data over the bus to the host device. The host device then stores the read data in a buffer and later sends the read data back to the memory device over the bus along with a standard write command that specifies a logical address of the destination location in the memory. The memory device then translates the logical address to a physical address and writes the data to the destination location.

There are several disadvantages associated with this process of copying and moving data. Since the host device is involved in every step of the process, this process occupies the central processing unit (CPU) of the host device, wastes power, blocks other user operations that otherwise could have been performed, and requires that the host device contain a buffer to store read data. This process also ties-up the communication bus between the host device and the memory device since data is sent from the memory device to the host device and then back to the memory device. Finally, it prevents the memory device management system from performing more sophisticated optimization, such as avoiding the copy operation entirely and simply changing the internal host to memory mapping.

While standard storage device interfaces do not define commands to trigger the memory device to perform a copy or move operation on its own based on logical addresses provided by the host device, a host device can provide a command to some NAND memory devices to copy or move data between physical addresses specified by the host device. This command would be performed on a raw Flash physical device level (i.e., on the memory chip itself) and would be issued by the host device, for example, to perform a wear leveling or erase block management operation. However, ECC operations are not performed in such copy/move operations at the physical device level because error correcting code (ECC) operations are performed by a component external to the memory chip. Accordingly, the memory chip does not check or regenerate ECC, so any errors that are present in the read data would be propagated.

### SUMMARY

The concept(s) presented herein can be implemented in various embodiments, and this summary includes a number of exemplary embodiments.

By way of introduction, the embodiments described below provide methods for writing data from a source location to a destination location in a memory device comprising a memory. In one embodiment, the memory device receives a command from a host device, wherein the command specifies a logical address of a source location in the memory and a logical address of a destination location in the memory. The memory device translates the logical addresses of the source and destination locations to physical addresses of the memory, reads data from the source location, and writes the data to the destination location. In this embodiment, the data is read from the source location and written to the destination location without a need of further involvement of the host device after the host device sends the command to the memory device. In another embodiment, a method is provided in which the memory device receives a copy or move command from a host device along with physical addresses of the source and destination locations. The memory device performs the copy or move operation and performs an ECC operation on the data read from the source location. Other embodiments are provided, and each of the embodiments described herein can be used alone or in combination with one another. Various embodiments will now be described with reference to the attached drawings.

### BRIEF DESCRIPTION OF THE DRAWINGS

FIG. 1 is a block diagram of a host device in communication with a memory device of an embodiment.

FIG. 2 is a flow chart of a method of an embodiment for writing data from a source location to a destination location in a memory device.

FIG. 3 is a flow chart of a method of another embodiment for writing data from a source location to a destination location in a memory device.

### DETAILED DESCRIPTION OF THE PRESENTLY PREFERRED EMBODIMENTS

The following embodiments are generally directed to methods for writing data from a source location to a destination location in a memory device. In general, these embodiments allows a host device to issue a command to copy or move data in a memory device, and the memory device will copy or move the data without the need of further involvement of the host device after the host device sends the command to the memory device. In this way, these embodiments overcome the disadvantages discussed above of the current process of copying and moving data in a memory device. Since the host device is not involved in every step of the process in these embodiments, the central processing unit (CPU) of the host device is free to perform other activities or can save power. Further, because the communication bus between the host device and the memory device is not tied-up in the process of copying or moving data in these embodiments, the communication bus is available for other actions. Additionally, since data need not be transferred to the host device in the copy/move operations in these embodiments, the host device does not need to dedicate a buffer for such operations, as in prior schemes.

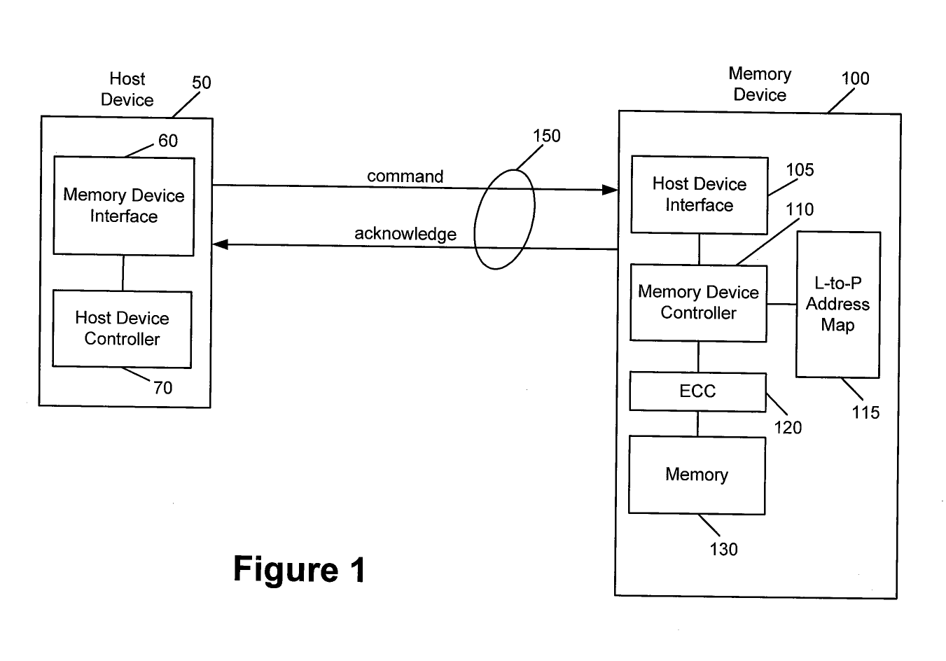

Turning now to the drawings, FIG. 1 is a block diagram of a host device 50 in communication with a memory device 100 of an embodiment via a communication bus 150. The communication bus 150 can use any suitable interface standard including, but not limited to, Serial Advanced Technology Attachment (SATA), Advanced Technology Attachment (ATA), Small Computer System Interface (SCSI), Fibre Channel, and Serial Attached SCSI (SAS).

As used herein, the phrase “in communication with” means in direct communication with or in indirect communication with via one or more components named or unnamed herein (e.g., a memory card reader). The host device 50 and the memory device 100 can be in communication with each other via a wired or wireless connection. For example, in one embodiment, the memory device 100 can comprise pins (or a socket) to mate with a corresponding socket (or pins) on the host device 50 to establish an electrical and physical connection. In another embodiment, the memory device 100 comprises a wireless transceiver to place the host device 50 and memory device 100 in wireless communication with each other.

The host device 50 can take any suitable form, such as, but not limited to, a personal computer, a mobile phone, a game device, a personal digital assistant (PDA), an email/text messaging device, a digital camera, a digital media (e.g., MP3) player, a GPS navigation device, and a TV system. The memory device 100 can also take any suitable form, such as, but not limited to, a universal serial bus (USB) device, a memory card (e.g., an SD card), a hard disk drive (HDD), a solid state drive (SSD), and a redundant array of independent disks (RAID). Also, instead of the host device 50 and the memory device 100 being separately housed from each other, such as when the host device 50 is a notebook computer and the memory device 100 is an SD card, the host device 50 and the memory device 100 can be contained in the same housing, such as when the host device 50 is a notebook computer and the memory device 100 is a hard disk drive (HDD) or solid-state drive (SSD) internal to the housing of the computer.

As shown in FIG. 1, the host device 50 of this embodiment comprises a memory device interface 60 and a host device controller 70. In general, the memory device interface 60 is configured to send commands and receive acknowledgments from the memory device 100 using the interface standard appropriate for the communication bus 150. The host device controller 70 is operative to control various operations of the host device 50. The memory device 100 contains a host device interface 105, which, complementary to the memory device interface 60 in the host device 50, is configured to receive commands and send acknowledgments to the host device 50 using the interface standard appropriate for the communication bus 150. The memory device 100 also contains a memory device controller 110 operative to control various operations of the memory device 100, a logical-to-physical (L-to-P) address map 115 to translate logical address provided by the host device 50 to physical addresses of the memory 130, an error correcting code (ECC) block 120 to perform ECC operations, and the memory 130 itself.

The memory 130 can take any suitable form, such as, but not limited to, a solid-state memory (e.g., flash memory), optical memory, and magnetic memory. While the memory 130 is preferably non-volatile, a volatile memory can also be used. Also, the memory 130 can be one-time programmable, few-time programmable, or many-time programmable. In one preferred embodiment, the memory 130 takes the form of a raw NAND die; however, a raw NOR die or other form of solid state memory can be used.

It should be noted that the host device 50 and the memory device 100 can comprise additional components, which are not shown in FIG. 1 to simplify the drawing. Also, in some embodiments, not all of the components shown are present. For example, when the memory device 100 takes the form of a HDD, instead of using a L-to-P address map 115, the memory device controller 110 can use an allocation table, an algebraic mapping algorithm, or a defect mapping table to perform the translation. It should also be noted that the various controllers, blocks, and interfaces can be implemented in any suitable fashion. For example, a controller can take the form of one or more of a microprocessor or processor and a computer-readable medium that stores computer-readable program code (e.g., software or firmware) executable by the (micro)processor, logic gates, switches, an application specific integrated circuit (ASIC), a programmable logic controller, and an embedded microcontroller, for example.

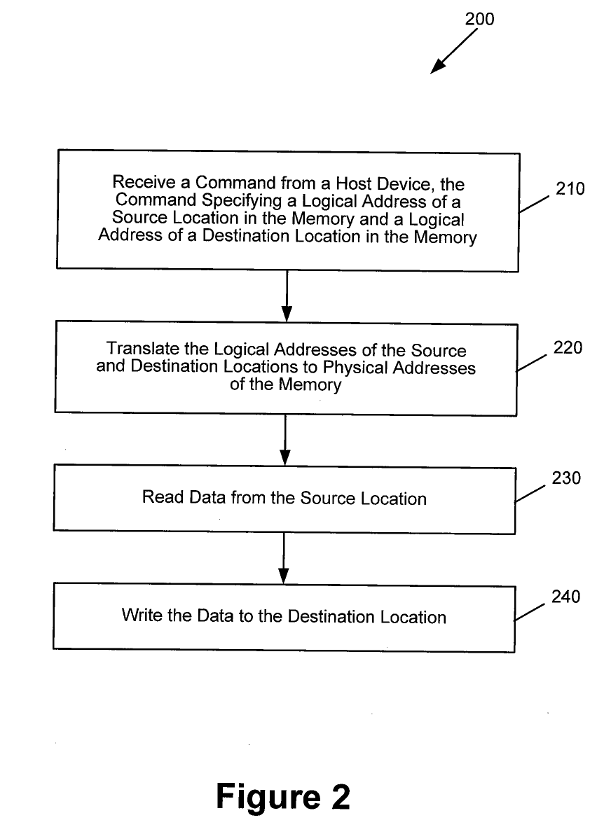

Turning back to the drawings, FIG. 2 is a flow chart 200 of a method for writing data from a source location to a destination location in the memory 130. First, the host device interface 105 receives a command from the host device 50, the command specifying a logical address of a source location in the memory 130 and a logical address of a destination location in the memory 130 (act 210). In response to receiving this command, the host device interface 105 can send an acknowledge signal back to the host device 50 to release the communication bus 150 after receiving the command. Next, the memory device controller 110 translates the logical addresses of the source and destination locations to physical addresses of the memory 130 (act 220). The memory device controller 110 can perform this translation by consulting the L-to-P address map 115, when such is present. Next, the memory device controller 110 reads the data from the source location in the memory 130 (act 230) and then writes the data to the destination location in the memory 130 (act 240). During this process, the ECC block 120 can perform an ECC operation on the data read from the source location in the memory 130.

It should be noted that, with this method, the data is read from the source location in the memory 130 and written to the destination location in the memory 130 without the need of further involvement of the host device 50 after the host device 50 sends the command to the memory device 100. In this way, this method overcomes the disadvantages discussed above of the current process of copying and moving data in a memory device. Since the host device 50 is not involved with the copy/move operation after it sends the initial command, the host device controller 70 in the host device 50 is free to perform other activities or just save power. Further, after the host device interface 105 sends an acknowledge signal back to the host device 50, the communication bus 150 is no longer dedicated to the copy/move operation and is, therefore, available for other communications. This saves time (since a communication protocol is not involved) and provides protection from communication errors and from of bus problems, including for example, the introduction of new errors, delays, and bus occupancy.

With the general method now described, the following paragraphs present details on various formats that can be used. It should be noted that these details are merely examples and should not be read into the claims unless explicitly recited therein. It is also contemplated that some of these formats can be added as a new communication protocol command to an existing interface standard, such as ATA/SCSI, SATA, SCSI (T10), USB 3.0, or SD 3.0, for example. Alternatively, these commands can be vendor-unique features.

One format issue relates to whether or not to specify an amount of data to handle in the operation. As mentioned above, the command from the host device 50 identifies the logical addresses of the source and destination locations (e.g., the “from_sector” and “to_sector”). In addition to specifying the logical addresses of the source and destination locations, the command can specify an amount of data (e.g., a number of sectors) to handle from the starting address. Alternatively, the amount of data to be handled from a given location can be imputed, so there would be no need to specify an amount of data to handle (e.g., in the case where the memory device 100 operates on a single-sector or single-page basis).

Another format issue relates to the disposition of the data at the source location after the data is written to the destination location. For example, in a typical copy operation, the data remains in the source location, whereas, in a typical move operation, some action may or may not be taken with respect to the data in the source location. In one embodiment, the command itself specifies a disposition of the data at the source location. For example, the command can comprise a parameter (e.g., a flag in the command string) that specifies the disposition of the data at the source location. In another embodiment, the disposition of the data at the source location is implicit in the command's schematic. For example, a “COPY_SECTORS” command can be defined such that the semantics of the command itself implies that the original sectors of data are to remain undisturbed after the data is written to the destination location. Similarly, a “MOVE_SECTORS” command can be defined such that the semantics of the command itself implies that some action is to be taken (e.g., logically delete the data in the source sectors) after the data is written to the destination location.

As noted above, disposition of the data at the source location can take various forms. For example, one type of disposition is to leave the data at the source location as-is. This type of disposition is consistent with what is typically considered a “copy” operation, since the data at the source location is left intact. Another type of disposition is to physically erase (e.g., either as a simple, one-pass erase or as a multi-pass secure erase) the data at the source location (e.g., by overwriting the data at the source location with zeroes). This type of disposition is consistent with what is typically considered a “move” or “cut-and-paste” operation, since the data at the source location is removed. This type of disposition may be preferred in security environments, where it is desired to avoid leaving data “residue” behind. Yet another type of disposition is to logically delete the data at the source location, which is referred to as “trimming.” With this type of disposition, the data at the source location is not physically erased, but an entry for the data in an allocation table or metadata for the file is marked as deleted, as invalid, or as unwritten. In this way, the trimmed sectors can be ignored in a garbage collection cycle, so they do not have to be moved. Since the data at the location is not physically erased, it can later be reclaimed, if desired. While either deleting or trimming can be used in certain types of memory devices, such as solid-state drives or other types of flash memory devices, trimming may not be an available option with memory devices that do not have an allocation table, such as hard disk drives. As yet another example of disposition types, a command can indicate a “don't care” condition for the data at the source location.

A host device can choose to use the copy/move command in any suitable situation. For example, a host device can issue a copy/move command in conjunction with a garbage collection operation or a wear leveling operation. As another example, a host device can issue a copy/move command as part of a disk defragmentation operation. On memory devices, such as hard disk drives, “white space” is left in the memory over time because copying or deleting files of different sizes or appending a file can create multiple fragments. Disk defragmentation puts all logical pieces of data physically together to eliminate the “white space” in the memory. A host device can issue the copy/move commands as part of the disk defragmentation operation to accelerate this operation. In this way, a solid-state drive can optimize the execution of either a copy command or a move command by combining it with a wear leveling or garbage collection operation performed by the solid-state drive as part of its internal operations. For example, if the source data is located in the middle of a block but a range of sectors is moved or copied, a space allocator in the memory device controller can re-align these sectors to the start of a block (with a move command, the source range can be trimmed or deleted). Because copy operations are performed frequently on a solid-state drive, these embodiments can be used to boost performance.

As other examples, a host device can issue a copy/move command as part of a file system copy operation (e.g., when copying from one sub-directory to another without involving the host device), as part of a file open/copy-on-write operation (e.g., copying a file when it is opened, writing to the copy instead of to the original file, and committing the copy and erasing the old one upon a save operation (if the copy is closed without saving, the copy is not kept)), or as part of a backup operation (e.g., making a logical copy of everything in all or part of the memory). These embodiments make these operations run faster, since the host device would not be involved in the operations after issuing the command.

As mentioned above, once the memory device receives the copy/move command from the host device, it can send an acknowledge signal back to the host device and release the communication bus, since the memory device controller performs the copy/move operation locally and no longer needs the interface. The memory device controller can perform the copy/move operation as a background operation of the memory device. However, while the memory device can prioritize when to execute the command (in part or in full), it is preferred that the memory device respect the semantics of later reads and writes to preserve temporal ordering. Consider, for example, the situation in which the host device sends a command to move a 100 MB region as part of a disk defragmentation operation. Since 100 MB may take a relatively long time to move, the memory device controller can by asynchronous in the sense that it is run in the background. If, during this time, the host device reads or writes data in some other memory area, the memory device controller can interrupt that move operation and perform the new read/write command. However, if the read/write operation occurs in the memory area that is the subject of the move command, the memory device controller would perform these commands synchronously to make sure the correct data is being read or written.

There are many alternatives that can be used with these embodiments. For example, while hard disk drives and solid state drives were discussed in the forgoing examples, as noted above, any type of suitable memory device can be used. Further, these embodiments can be used in a RAID subsystem to achieve similar advantages in optimizing performance and resource utilization, while taking advantage of efficiencies in RAID parity calculations and the number of physical I/Os performed. Accordingly, these embodiments can be used to make RAID controllers and subsystems more efficient.

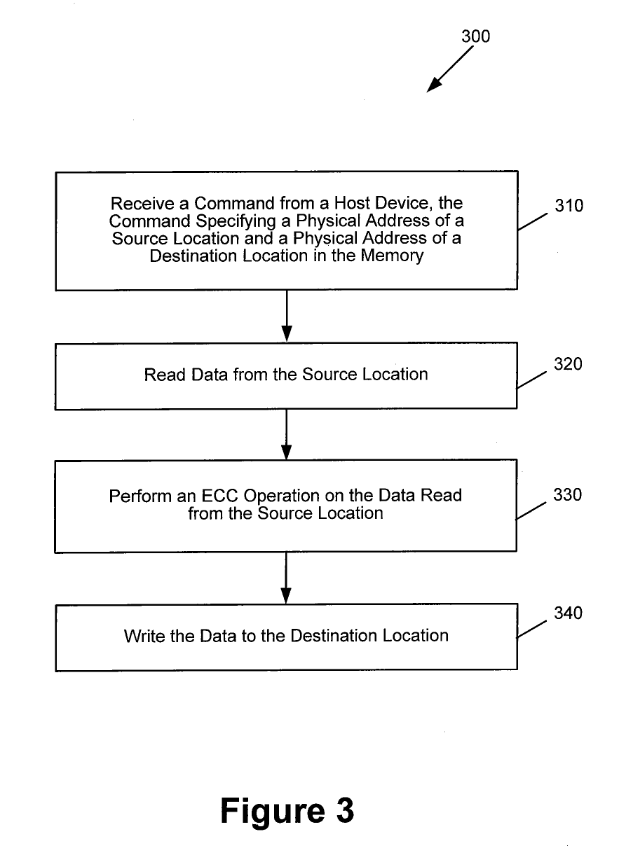

Returning to the drawings, the flow chart 300 in FIG. 3 presents a method of another alternate embodiment. In this embodiment, the memory device receives a command from the host device that specifies physical addresses (not logical addresses) of source and destination locations in the memory (act 310). The memory chip itself executes the command by reading data from the source location (act 320) and writing the data to the destination location (act 340). However, unlike prior memory devices, the memory device controller performs an ECC operation on the data read from the source location (act 330). Because the memory device controller performs an ECC operation, the memory device checks and regenerates ECC to prevent any errors in the data from propagating. To optimize this operation, instead of transferring all the data serially, the data can be transferred in parallel to help improve performance.

It is intended that the foregoing detailed description be understood as an illustration of selected forms that the invention can take and not as a definition of the invention. It is only the following claims, including all equivalents, that are intended to define the scope of this invention. Finally, it should be noted that any aspect of any of the preferred embodiments described herein can be used alone or in combination with one another.

1. A method for writing data from a source location to a destination location in a memory device, the method comprising:
in a memory device comprising a memory:
(a) receiving a command from a host device, the command specifying a logical address of a source location in the memory, a logical address of a destination location in the memory, and a disposition of data at the source location;
(b) translating the logical addresses of the source and destination locations to physical addresses of the memory;
(c) reading the data from the source location; and
(d) writing the data to the destination location;
wherein the data is read from the source location and written to the destination location without a need of further involvement of the host device after the host device sends the command to the memory device.

2. The method of claim 1, wherein the memory device is in communication with the host device via a bus, and wherein the method further comprises releasing the bus after receiving the command from the host device.

3. The method of claim 1 further comprising performing an error correcting code (ECC) operation on the data read from the source location.

4. The method of claim 1, wherein the command specifies an amount of data to handle.

5. (canceled)

6. The method of claim 1, wherein the command specifies that the data at the source location is to be left intact.

7. The method of claim 1, wherein the command specifies that the data at the source location is to be logically deleted.

8. The method of claim 1, wherein the command specifies that the data at the source location is to be physically erased.

9. The method of claim 1, wherein the command specifies a don't care condition for the data at the source location.

10. The method of claim 1, wherein the command comprises a parameter that specifies the disposition of the data at the source location.

11. The method of claim 1, wherein the disposition of the data at the source location is implicit in the command's schematic.

12. The method of claim 1, wherein (b)-(d) are performed as background operations of the memory device.

13. The method of claim 1, wherein (b)-(d) are performed in conjunction with a wear leveling operation.

14. The method of claim 1, wherein (b)-(d) are performed in conjunction with a garbage collection operation.

15. The method of claim 1, wherein the command is issued by the host device as part of a disk defragmentation operation.

16. The method of claim 1, wherein the command is issued by the host device as part of a file system copy operation.

17. The method of claim 1, wherein the command is issued by the host device as part of a file open/copy-on-write operation.

18. The method of claim 1, wherein the command is issued by the host device as part of a backup operation.

19. The method of claim 1, wherein the memory device comprises a hard disk drive.

20. The method of claim 1, wherein the memory device comprises a solid state drive.

21. The method of claim 1, wherein the memory device is part of a redundant array of independent disks (RAID).

22. The method of claim 1, wherein the memory device comprises a removable memory card.

23. The method of claim 1, wherein the memory device comprises a memory card embedded in the host device.

24. The method of claim 1, wherein the memory comprises a raw NAND die.

25-40. (canceled)
